(19) United States
(12) Patent Application Publication
(10) Pub. No.: US 2017/0199630 A1
(43) Pub. Date: Jul. 13, 2017

(54) NOSTALGIC CONTENT SYSTEM FOR MULTIMEDIA SERVICE PROVIDER

(71) Applicant: Sony Computer Entertainment America LLC, San Mateo, CA (US)

(72) Inventors: David Perry, Dana Point, CA (US); Ryan Breed, Laguna Niguel, CA (US)

(21) Appl. No.: 14/994,368

(22) Filed: Jan. 13, 2016

(51) Int. Cl. G06F 3/0482; H04L 29/08

(52) U.S. Cl. CPC G06F 3/0482; H04L 67/10; G06Q 50/01

(57) ABSTRACT

Methods, systems, and computer programs are presented for presenting nostalgic items in a user interface. One method includes an operation for identifying, by a server, a plurality of nostalgia groups, each nostalgia group including one or more group parameters that define which multimedia items are associated with the nostalgia group, such as a time period. The method further includes operations for determining membership of a user in a first nostalgia group from the plurality of nostalgia groups based on user information about the user, and for receiving a request from a computing device of the user to access a multimedia interface. The method further includes operations for selecting one or more nostalgia multimedia items for the user based on the membership of the user in the first nostalgia group, and for sending the multimedia interface that includes the selected one or more nostalgia multimedia items.

### BACKGROUND

1. Field of the Invention

The present embodiments relates to methods, systems, and programs for recommending multimedia items in a user interface.

2. Description of the Related Art

The amount of content available online for user consumption has been growing quickly over the last decade. As a result, users have more options for accessing music, movies, games, etc., including multiple platforms for delivering multimedia to users. However, there is so much content available that users may have difficulty finding items of their liking.

Some multimedia providers give suggestions to users based on the past selections of the user, under the assumption that users tend to like media that is similar to other media consumed previously. However, basing suggestions just on past history limits the amount of possibilities for the users because users may have other areas of interest that the users haven't tapped yet, or because users have accessed other types of items in other platforms.

It is in this context that embodiments arise.

### SUMMARY

Methods, devices, systems, and computer programs are presented for presenting nostalgic items in a user interface. It should be appreciated that the present embodiments can be implemented in numerous ways, such as a method, an apparatus, a system, a device, or a computer program on a computer readable medium. Several embodiments are described below.

One general aspect includes a method for creating a user interface for a computing device. The method includes an operation for identifying, by a server, a plurality of nostalgia groups, where each nostalgia group includes one or more group parameters that define which multimedia items are associated with the nostalgia group, where the one or more group parameters include a time period. The method also includes an operation for determining membership of a user in a first nostalgia group from the plurality of nostalgia groups based on user information about the user. The method also includes an operation for receiving, by the server, a request from a computing device of the user to access a multimedia interface, the multimedia interface providing access to a plurality of multimedia items. The method further includes operations for selecting, by the server, one or more nostalgia multimedia items for the user based on the membership of the user in the first nostalgia group, and for sending, from the server to the computing device, the multimedia interface for the user, where the multimedia interface includes the selected one or more nostalgia multimedia items. In one instance, the operations of the method are executed by a processor.

One general aspect includes a server for providing a multimedia interface. The server includes a memory, a network connection, and a processor. The memory is for storing a computer program and information about a plurality of nostalgia groups, where each nostalgia group includes one or more group parameters that define which multimedia items are associated with the nostalgia group, where the one or more group parameters include a time period. The network connection is configured to receive a request from a computing device of a user to access a multimedia interface, the multimedia interface providing access to a plurality of multimedia items. The processor is configured to execute the computer program, where the processor determines membership of the user in a first nostalgia group from the plurality of nostalgia groups based on user information about the user. Further, the processor selects one or more nostalgia multimedia items for the user based on the membership of the user in the first nostalgia group. The processor further sends to the computing device, via the network connection, the multimedia interface for the user, the multimedia interface including the selected one or more nostalgia multimedia items.

One general aspect includes a non-transitory computer-readable storage medium storing a computer program for creating a user interface for a computing device. The computer-readable storage medium includes program instructions for identifying, by a server, a plurality of nostalgia groups, where each nostalgia group includes one or more group parameters that define which multimedia items are associated with the nostalgia group, where the one or more group parameters include a time period. The storage medium also includes program instructions for determining membership of a user in a first nostalgia group from the plurality of nostalgia groups based on user information about the user. The storage medium further includes program instructions for receiving, by the server, a request from a computing device of the user to access a multimedia interface, the multimedia interface providing access to a plurality of multimedia items. The storage medium also includes program instructions for selecting, by the server, one or more nostalgia multimedia items for the user based on the membership of the user in the first nostalgia group. The storage medium also includes program instructions for sending, from the server to the computing device, the multimedia interface for the user, where the multimedia interface includes the selected one or more nostalgia multimedia item.

Other aspects will become apparent from the following detailed description, taken in conjunction with the accompanying drawings.

### BRIEF DESCRIPTION OF THE DRAWINGS

The embodiments may best be understood by reference to the following description taken in conjunction with the accompanying drawings.

FIG. 1 is a user interface for accessing multimedia items, according to one embodiment.

FIG. 2 shows a schematic diagram of a networked environment for accessing multimedia items, according to one embodiment.

FIG. 3 illustrates a method for obtaining recommendations of nostalgic content, according to one embodiment.

FIG. 4 illustrates the definition of nostalgia groups, according to one embodiment.

FIG. 5 is a flowchart for determining nostalgia group membership and nostalgia group candidates, according to one embodiment.

FIG. 6 illustrates the creation of nostalgia groups, according to one embodiment.

FIG. 7 is a flowchart of a method for presenting nostalgic items in a user interface, according to one embodiment.

FIG. 8 is a simplified schematic diagram of a computer system for implementing embodiments.

FIG. 9 is a block diagram of a game system, according to various embodiments.

FIG. 10A illustrates a simplified block diagram of an exemplary system that is used to preload game content onto a cloud game server, in accordance with an embodiment.

FIG. 10B is a flow diagram conceptually illustrating various operations which are performed for streaming a cloud video game to a client device, in accordance with implementations of the disclosure.

### DETAILED DESCRIPTION

The following embodiments describe methods, devices, systems, and computer programs for presenting nostalgic items in a user interface. Nostalgia is a strong sentiment in many people. For example, playing music from an earlier period in life where the user was happy will likely bring good memories and good feelings to the user. By finding nostalgic content, it is more likely that users will accept recommendations from the system, therefore, spending more time accessing multimedia from the service provider.

Selecting nostalgic content goes beyond the basic concept of providing recommendations based on the history of selections, because the history may not show items that may interest the user. For example, recommendation systems do not often recommend movies that are 20 years old, but if a movie has a theme, or is from a certain era, that brings good memories to the user, the user will be inclined to make the selection of the old movie.

One method includes an operation for identifying, by a server, a plurality of nostalgia groups, each nostalgia group including one or more group parameters that define which multimedia items are associated with the nostalgia group, such as a time period. The method further includes operations for determining membership of a user in a first nostalgia group from the plurality of nostalgia groups based on user information about the user, and for receiving a request from a computing device of the user to access a multimedia interface. The method further includes operations for selecting one or more nostalgia multimedia items for the user based on the membership of the user in the first nostalgia group, and for sending the multimedia interface that includes the selected one or more nostalgia multimedia items.

It will be apparent, that the present embodiments may be practiced without some or all of these specific details. In other instances, well-known process operations have not been described in detail in order not to unnecessarily obscure the present embodiments.

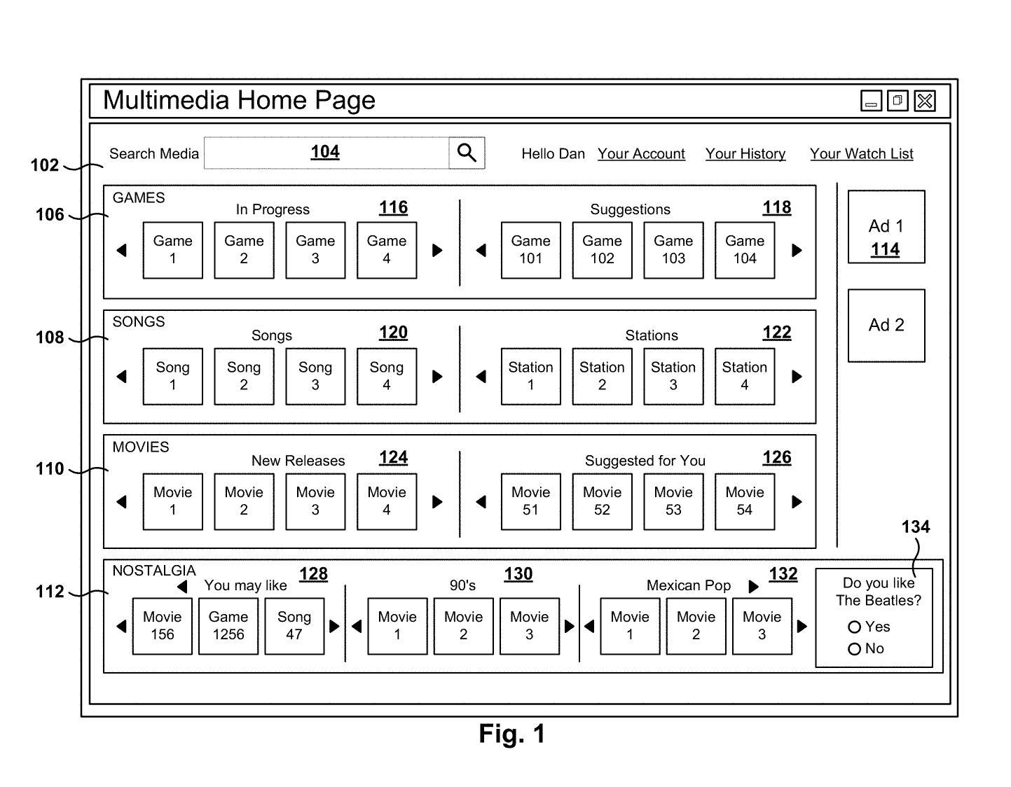

FIG. 1 is a user interface for accessing multimedia items, according to one embodiment. FIG. 1 is an example of a web page 102 communicated over the Internet that allows users to select multimedia content for streaming. Embodiments presented herein will be described with reference to web access to multimedia, but the same principles apply to any other type of access, such as on-demand access provided by a cable television or satellite provider.

Webpage 102 provides several areas for selecting multimedia items. In one embodiment, the selection areas include a games section 106, a songs section 108, a movie section 110, and a nostalgia section 112. In addition, webpage 102 provides other options, such as a search box 104, and other support options, such as accessing information about the user account, the user history, a watch list, etc. Further yet, the webpage 102 includes, in one embodiment, advertisements 114. The advertisements may be selected randomly, or maybe targeted for that specific user.

Embodiments are presented herein with reference to games, music, and movies, but the principles presented may be utilized for any other type of multimedia content, such as books, blogs, TV series, sports events, pay-per-view events, etc.

Games section 106 includes an area for in-progress games 116 (e.g., games 1-4) and a suggestions area 118, which includes suggestions for games that the user has not played before. In each of the areas there are selection arrows aiming left or right that can be used by the user to scroll through the possible items in the area.

Songs section 108 includes an area for selecting songs 120 and another area 122 for selecting music stations (e.g., current hits, country music, classical music, news, sports, etc.). In another embodiment, a song suggestion section is also provided (not shown).

Movie section 110 includes an area that presents new releases 124 (e.g., movies 1-4), and a second area for movie suggestions 126 (e.g., movies 51-54). In one embodiment, the suggestions for the user are based on the past selections of the user, but other types of suggestions are also possible, such as popular content, sponsored content, new releases, etc.

The nostalgia section 112 presents items aimed at appealing to the nostalgic feelings of the user. In one embodiment, nostalgia is defined as a wistful desire to return in thought or in fact to a former time in a person's life, to a person's home or homeland, or to a person's family and friends; a sentimental yearning for the happiness of a former place or time. In other words, nostalgia appeals to past experiences of the user, that may be related to a time period, a geographic location, a special event (e.g., a wedding), a milestone (e.g., passing the bar exam, graduating high school), a historic event (e.g., the race to step on the moon, the second world war), etc.

Nostalgia section 112 includes, in one embodiment, an area of suggestions 128, an area for a first nostalgia group or category 130 (e.g., items related to the nineties), an area for a second nostalgia group (e.g., Mexican popular music of the last decade), and a nostalgia question box 134. Embodiments presented herein provide for nostalgic content selection and for recommending nostalgic content.

The nostalgia question box 134 is used for asking nostalgia-related questions in order to determine if the user belongs to a particular nostalgia group. For example, one question may be “Do you like The Beatles?” The answer is used to determine if the user is nostalgic for Beatles music. The nostalgia question may not be presented all the time, but only presented at certain times, in order not to overwhelm the user with questions. For example, the nostalgia question may be presented sometimes after the user makes a music selection, or when the user first logs in to the webpage. In one embodiment, the nostalgia questions are optional and the user is not forced to answer the nostalgia questions. Further yet, the nostalgia question may be also presented in different formats, such as a pop-up window presented on the center of webpage 102, etc.

The nostalgia question may be a direct question, such as “Do you like the nineties?” Or the nostalgia question may be a trivia question, such as a multiple choice question to indicate if the user is knowledgeable of certain subject. Knowing if the user knows a certain fact, increases the probability that the user would be nostalgic for that content. For example, a question may be, “Which eighties pop singer/group had their Grammy revoked for allegedly not singing the vocals on their album?” The multiple choice answers are: Culture Club, Prince, Milli Vanilli, and Madonna. If the user knows the answer, the probability that the user likes the eighties is increased. When the probability is greater than a predetermined threshold, then the system adds the user to the nostalgia group for the eighties.

The system asks simple questions to narrow the nostalgia groups of interest to the user. The questions may be related to an era, or to games related to sailing (e.g., system may ask if the user likes Gilligan's island), or to James Bond movies, or to which country the user is from, or where did the user live when the user got married, etc.

In other embodiments, the nostalgia suggestions are included with the other types of suggestions, e.g., nostalgia game suggestion in game suggestions area 118, or nostalgia movie suggestion in movie suggestions area 126.

It is noted that the embodiments illustrated in FIG. 1 are exemplary. Other embodiments may utilize different layouts, fewer or additional options, etc. The embodiments illustrated in FIG. 1 should therefore not be interpreted to be exclusive or limiting, but rather exemplary or illustrative.

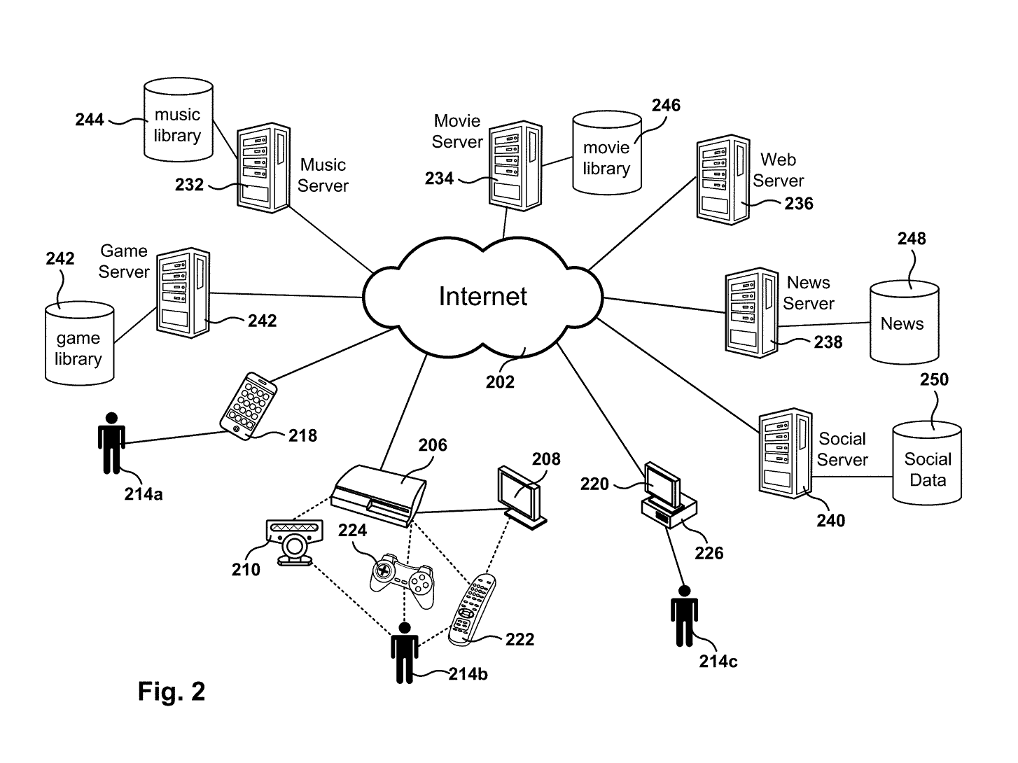

FIG. 2 shows a schematic diagram of a networked environment for accessing multimedia items, according to one embodiment. There is a plurality of servers connected to Internet 202 that provide different types of multimedia-delivery services. A web server 236 provides multimedia-access web pages to users 214a-214c (e.g., using standard http (Hypertext Transfer Protocol) transfers or any other message exchange mechanism). For example, web server 236 creates the interface described above with reference to FIG. 1.

Users 214a-214c can access multimedia content through any device, such as mobile phone 218, game console 206, personal computer (226) with display 220, Personal Digital Assistants (PDA), laptops, workstations, television 208, etc. The users may enter input via mouse, or keyboard, a touch screen or a numeric keypad, camera 210 (to capture player movement and sound), controller 224, remote control 222, etc.

Game server 242 provides game access to users. The game server includes, or is connected to, a game library 242 with a plurality of games that may be accessed over the Internet 202. When a user requests a game, the game server 242 may send the game to the user's device, or the game server 242 may execute the game and provide an interface for accessing the game remotely.

Music server 232 delivers songs to the remote users, and music server 232 interfaces with a music library 244 that stores the available songs for downloading or streaming. Similarly, movie server 234 provides movie access to the remote users, and a movie library 246 stores the movies available for download or remote viewing. The news server 238 provides news 248 for the users.

Social server 240 manages a social network and provides the services associated with the social network. Social server 240 stores social data 250 that includes data associated with the social network, such as user profiles, friendship relationships between users, messages exchanged between users, friendship requests, etc.

In one embodiment, the social server 240 provides an Application Programming Interface (API) to the other servers, and the API is utilized to access the services of the social network to obtain information from the social network or to submit requests to the social network. For example, the API allows other servers to post requests, obtain user profile information, obtain information about who are the friends of a user, user activity, user likes, etc. Of course, the information provided is made available only when privacy settings of the user's allow for the exchange of that information.

In some embodiments, other APIs are provided by the other servers in order to access server-related information. For example, the game server 242 provides an API to access game information, such as games available, game user activity, games played by a user, social relationships established within the game, etc. In some embodiments, the music server 232, movie server 234, news server 238 also provide respective APIs for accessing data and exchanging communications between the different servers and between the servers and the clients.

It is noted that the embodiments illustrated in FIG. 2 are exemplary. Other embodiments may utilize different servers, distributed servers, or combine the functionality of several servers into a single server, additional servers (e.g., providing book services), etc. The embodiments illustrated in FIG. 2 should therefore not be interpreted to be exclusive or limiting, but rather exemplary or illustrative.

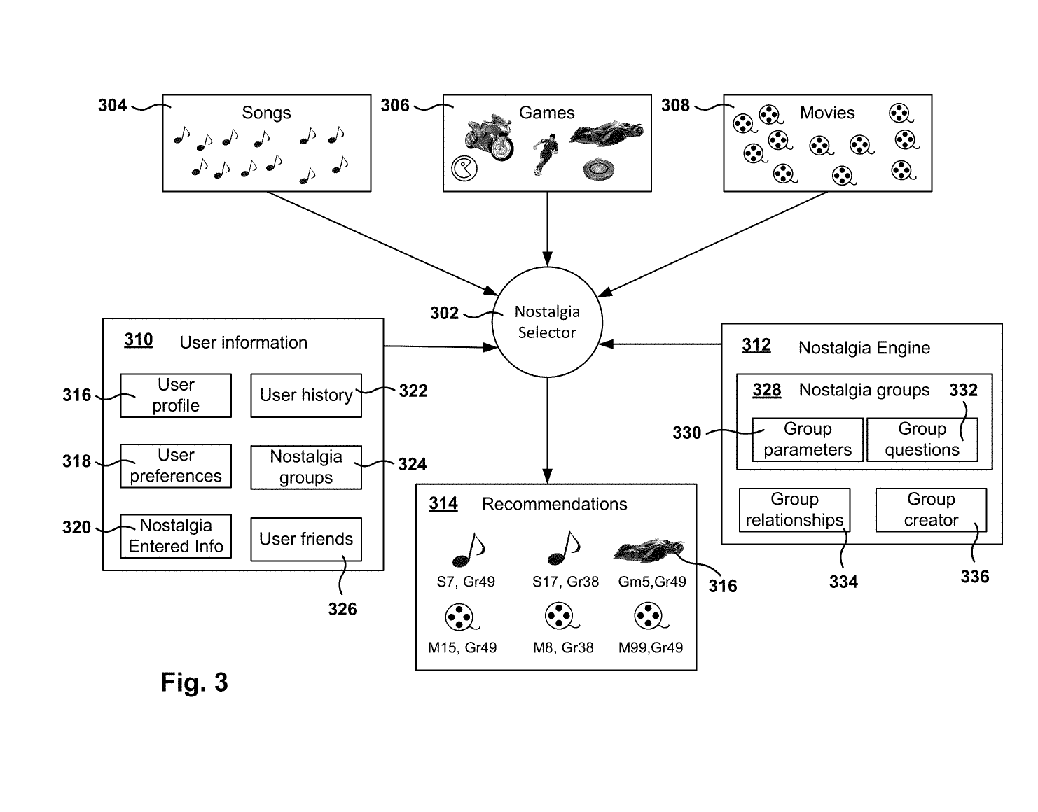

FIG. 3 illustrates a method for obtaining recommendations of nostalgic content, according to one embodiment. Nostalgia selector 302 analyzes user information 310 and input from the nostalgia engine 312 to determine nostalgia recommendations 314 from the available library (songs 304, games 306, and movies 308) for a particular user. The recommendations might be of any type (song, game 316, movie, etc.) and from one or more nostalgia groups (e.g., group 49 Gr49, group 38 Gr38, etc.)

The user information 310 includes one or more of user profile information 316, user history 322, user preferences 318, user membership in nostalgia groups of 324, nostalgia-related information 320, and/or friend-related information 326.

Information about the user profile 316 may be obtained by the multimedia service provider, or may be obtained from profiles of the user in a social network, or in some other service linked to the user (e.g., game service, music service, movie service, book service, etc.) User profile information 316 is useful to determine nostalgic recommendations and may include one or more of the age of the user (e.g., to determine eras where the user was in high school, or in college, or a teenager, etc.), the birthplace of the user (e.g., to determine membership in nostalgia groups associated with a particular geography, such as a state, and nation, a neighborhood, etc.), the favorite sport teams of the user, etc.

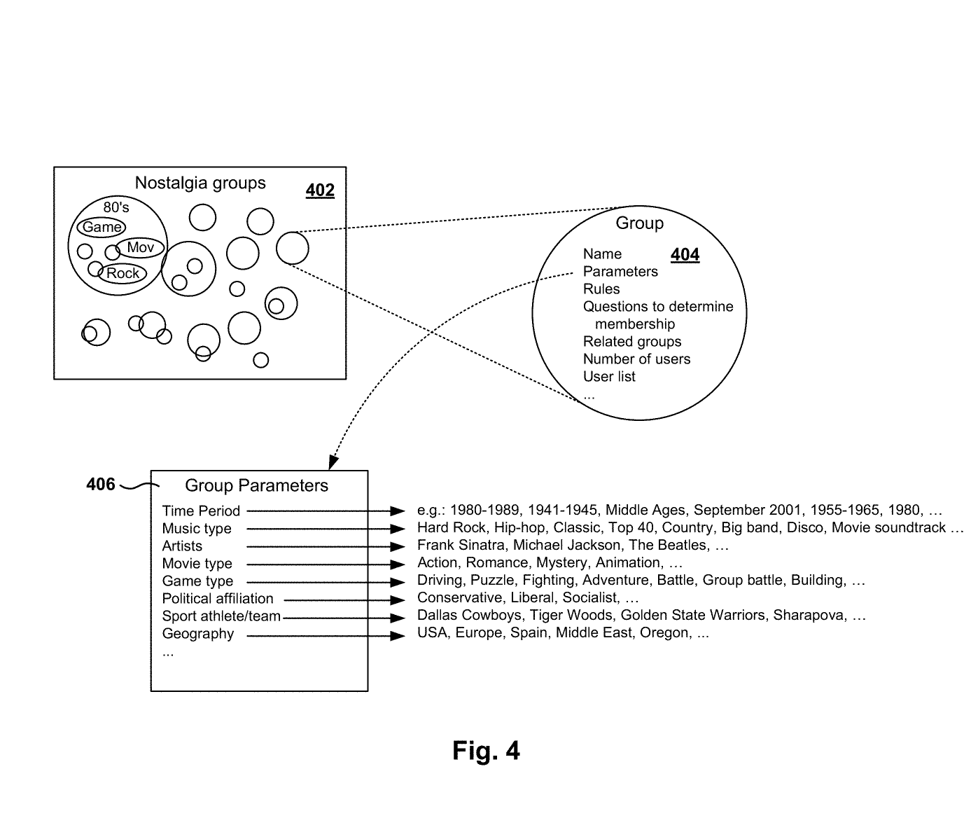

User history 322 includes information related to previous user activity, such as games played, songs chosen or purchased, movies watched, movies browsed, books read, products bought (e.g., a Star Wars uniform), etc. Further, user preferences 318, which in some embodiments may be part of the user profile 316, identify preferences expressed by the user, such as the “likes” of the user in a game or a social network, favorite music artists, favorite movies, favorite genre, favorite books, etc. The user nostalgia groups are managed by the nostalgia engine, where each nostalgia group identifies which multimedia items belong within a certain nostalgia group. More details are provided below regarding nostalgia groups with reference to FIG. 4.

The nostalgia-related information 320 is information entered by the user 320 that assists in determining membership of the user in one or more nostalgia groups. For example, the nostalgia-related information includes the answers to questions presented in the nostalgia interface. The nostalgia-related information 320 includes answers of the user to the nostalgia-related questions, where the membership of the user in the nostalgia groups is inferred from the answers of the user to the nostalgia-related questions. In one embodiment, each nostalgia-related question is associated with a respective nostalgia time period. In one embodiment, the system can infer the nostalgia groups based on previous responses by other users that have similar characteristics, based on their user accounts and profiles. For example, the similar characteristics can be data mined to find intersections between similarities in the responses and also in content found in the user profiles. The inferences can be assigned weighting functions, which change over time based on more occurrences in similarities or fewer occurrences and similarities. By way of example, if more occurrences in similarities happened during specific periods of time, or based on similarly liked or purchased multimedia content, the weighting function can be increase to indicate a higher likelihood that inference will identify the correct nostalgia group. Over time, this analysis can be fined tuned based on additional inputs received from the user, inputs received from similar users, and combinations thereof.

In one embodiment, the nostalgia-entered information 320 also include other information entered by the user (which is not part of the user profile) in different contexts (e.g., music survey) and can also be used to prove membership in one or more nostalgia groups.

Information of user's friends 326 includes information regarding friends of the user, where this information may be utilized by association to determine membership of the user in nostalgia groups. For example, if five friends of the user like sixties science fiction, there will be a high probability that the user will also like sixties science fiction. Information for user's friends 326 includes one or more of friend profile, friend history, friend preferences, friend nostalgia memberships group, friend nostalgia-entered information, etc.

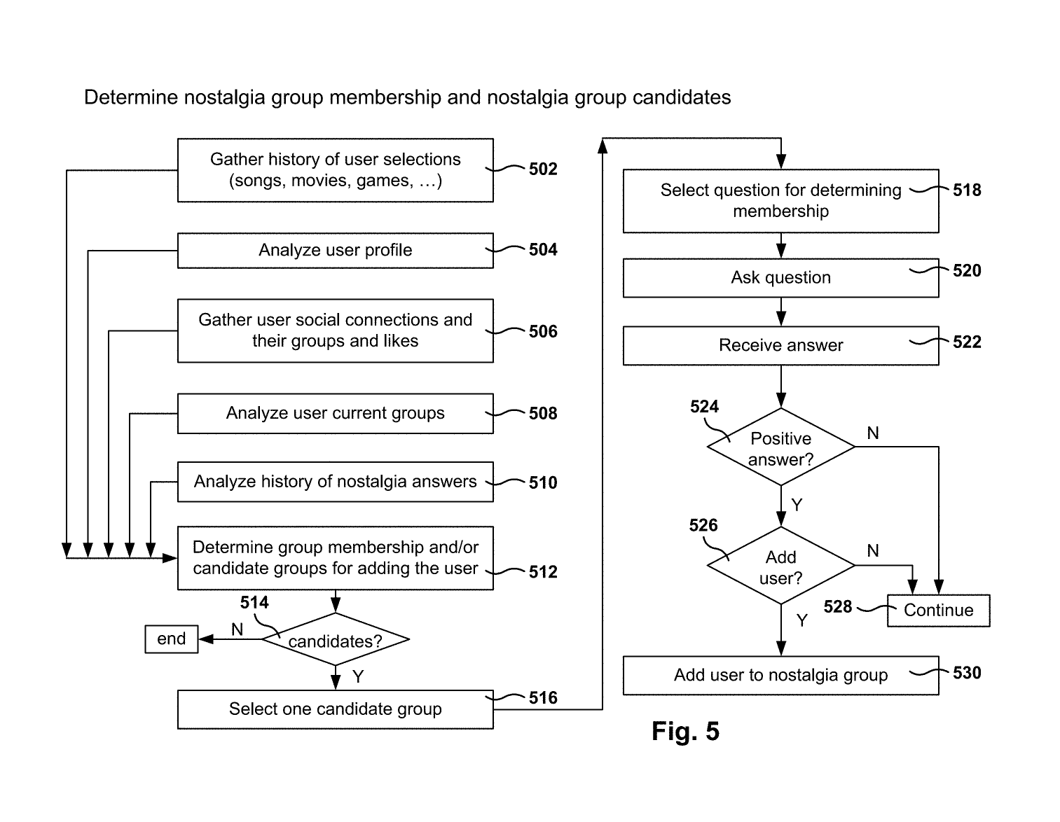

The nostalgia engine 312 manages the creation and management of nostalgia groups 328. A nostalgia group is a collection of multimedia items that meet a certain criteria. These criteria are defined by a plurality of nostalgia parameters, described in more detail below with reference to FIG. 5. The purpose of a nostalgia group is to define items that appeal to a nostalgic feeling of a user. Nostalgia groups 328 also include one or more questions that may be asked to the user for determining membership in one or more nostalgia groups.

The nostalgia engine 312 further includes linkages between the nostalgia groups, referred to as nostalgia group relationships 334. The nostalgia group relationships assist the nostalgia engine 312 in determining candidate nostalgia groups for membership of the user. For example, a user, that is a member of an eighties nostalgia group and member of another nostalgia group for a popular actor that plays romantic roles, will have a high probability of wishing to be added to a nostalgia group for romantic movies of the eighties.

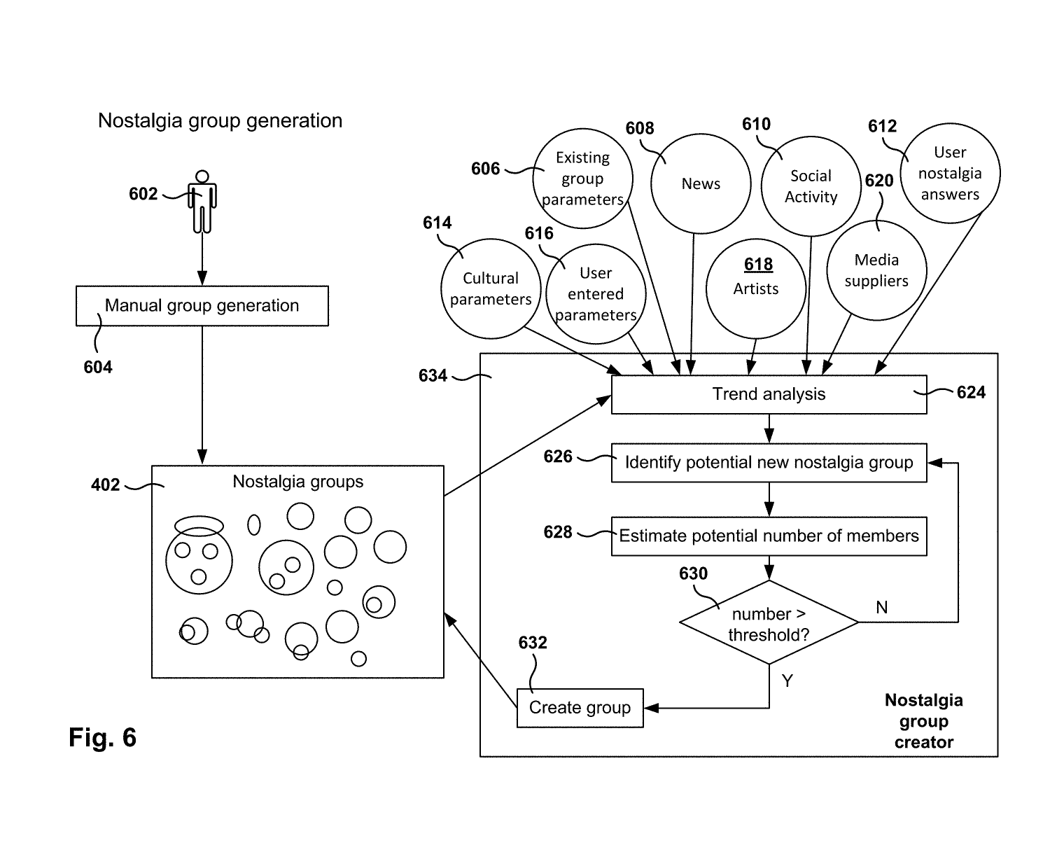

The group creator 336 identifies how each nostalgia group was created, such as by a person, or automatically generated by a computer algorithm. More details about the generation of nostalgia groups are provided below with reference to FIG. 6.

FIG. 4 illustrates the definition of nostalgia groups 402, according to one embodiment. As illustrated in FIG. 4, the nostalgia groups may overlap with each other or some nostalgia groups may include other smaller nostalgia groups. For example, an eighties nostalgia group may be associated with anything related to the eighties, and includes other nostalgia groups such as computer games of the eighties, movies of the eighties, rock 'n roll music of the eighties, etc.

In one embodiment, each nostalgia group 404 includes a name of the group (e.g., popular fifties songs), group parameters 406, group rules, one or more questions to determine membership in the group, related groups, number of current users that are members of the group, a user list, etc.

The group parameters 406 are used to define which multimedia items belong to the nostalgia group. The group parameters 406 include one or more of the following:

Time period, which defines an era associated with the nostalgia group, such as Middle Ages, or a decade, or a century, or one or more years, or a specific date associated with an event, or any other type of criteria that defines the time period (e.g., a start date and an end date).

Music type, such as hard rock, hip-hop, classic, top 40, country, big band, disco, movie soundtrack, etc.

An artist, such as an actor or actress, a singer, a music group, a writer, etc.

A movie type, such as action, romance, mystery, animation, etc.

A game type, such as driving games, puzzle games, fighting games, adventure games, battle games (e.g., boxing, warfare), group battle games, building games, etc.

A political affiliation, such as conservative, liberal, socialist, communist, etc.

An athlete or a sport team, such as Dallas Cowboys, Tiger Woods, Golden State Warriors, Sharapova, etc.

A geographical location, such as a neighborhood, a city, a state, country, a continent, etc. (e.g., USA, Europe, Spain, Middle East, Oregon).

When a group parameter is not defined, it is assumed that the other parameters are used to determine which groups belong in the nostalgia group. For example, one nostalgia group associated with the eighties, has one parameter defined: time period =1980-1989, while the rest of the parameters are undefined, similar to being defined as a wild card.

In one embodiment, rules may be defined to further clarify the parameters, where the rules include logical relationships between the parameters or other group items to further refine which items belong in the nostalgia group.

The questions for determining membership are inquiries for presentation to the user, such that an answer to a question helps determining if the user belongs to the nostalgia group. Some questions may be completely define if a user belongs to the nostalgia group, such as “Do you like the eighties?” to determine membership on the eighties groups. Other questions may provide information to narrow the affinities of the user, and the system combines answers for more than one question to assess membership. For example, “Do you like music? may be a question used to determine membership in music-related nostalgia groups.

One of the goals is to give users simple questions about their interests so the questions can be answered quickly and users are motivated to answer them. The questions may be asked at any time, but it may be more appropriate to present them right after the user makes a selection (e.g., an old movie). For example, if the user selects a Madonna song, the nostalgic window may ask the user, Do you like the eighties? Or, Did you listen to the music in the eighties?

Further, some of the answers may be utilized to determine membership in more than one group. For example, if the user says that she likes Madonna, then the nostalgia selector knows that the user likes eighties music, and the user may also like other things of the eighties, such as movies. This way, the selector aims at figuring out a time period beyond the time period related to the user lifespan, as for example, the user may have been born in the nineties but the user likes the music of the eighties (e.g., the user grew up in a home where eighties music was often heard). Also, a user may like French culture, even though the user may have never been to France.

In general, the questions may be related to the user profile (e.g., age, birthplace), a similar artist to another one the user likes, user likes and preferences, learning habits of the user, information from social networks, etc. Or a random question may be introduced at times to explore other possible nostalgia eras.

It is noted that the embodiments illustrated in FIGS. 3-4 are exemplary. Other embodiments may utilize different parameters, selection criteria, organization, etc. The embodiments illustrated in FIGS. 3-4 should therefore not be interpreted to be exclusive or limiting, but rather exemplary or illustrative.

FIG. 5 is a flowchart for determining nostalgia group membership and nostalgia group candidates, according to one embodiment. While the various operations in this flowchart are presented and described sequentially, one of ordinary skill will appreciate that some or all of the operations may be executed in a different order, be combined or omitted, or be executed in parallel.

In operation 502, the nostalgia system gathers information about the history of user selections (e.g., songs selected or purchased, movies rented or purchased, games played, products bought, searches made, etc.)

In operation 504, the user profile is analyzed to obtain information that may assist the nostalgia engine in determining whether the user would be more likely or less likely to be a member of any of the nostalgia groups. The information that may be useful includes date of birth, birthplace, favorite artist, etc.

Further, in operation 506, the system gathers information about user social connections in one or more social websites to determine the identities of friends of the user. The system further collects information about the friends of the user, such as their profile information or their preferences.

In operation 508, the nostalgia engine analyzes in which nostalgia groups the user is already a member. By analyzing existing nostalgia group membership, the system is able to determine other nostalgia groups that may be of interest to the user. In operation 510, the system analyzes the history of answers to nostalgia-related questions.

In operation 512, the nostalgia engine or nostalgia selector determines the group memberships for the user, and/or candidate nostalgia groups for adding the user, taking into consideration the information gathered or determined in operations 502, 504, 506, 508, and 510.

From operation 512, the method flows to operation 514, where a check is made to determine if there are one or more candidate nostalgia groups for the user. If there is one or more candidate nostalgia groups, the method flows to operation 516, where the first nostalgia candidate group is selected.

The nostalgia window aims at appealing to the user's nostalgia and to determine one or more nostalgia groups where the user is a fit. It could be time in high school, it could be college years, it could be preteen years, etc. But there are other factors to be considered as, for example, a 30 year old person may like fifties music.

From operation 516, the method flows to operation 518 where a question for determining membership in the candidate nostalgia group is selected. The goal for the nostalgia engine is to be as little intrusive as possible, in order to elicit cooperation from the user in answering the nostalgia questions. The questions may be periodically displayed to avoid being a nuisance (i.e., ask questions constantly).

In operation 520, the question is presented to the user (e.g., in nostalgia question box 134 of FIG. 1). After the answer to the question is received in operation 522, the method flows to operation 524 where a check is made to determine if the answer provided a positive clue towards adding the user to the candidate group. If the answer was not positive, the method flows to operation 528 to continue with the next nostalgia question for the next nostalgia group candidate, if any. If the answer is positive, the method flows to operation 526, where the nostalgia engine determines if there is enough information to add the user to the nostalgia group. If there is enough information to add the user to the nostalgia group, the user is added in operation 530.

FIG. 6 illustrates the creation of nostalgia groups, according to one embodiment. In one embodiment, the nostalgia groups 402 may be created manually 604 or by a nostalgia group creator 634 computer program. The manual group generation 604 involves the creation of nostalgia groups by a person 602, where the person is provided a user interface to identify values for the nostalgia parameters and other variable that define the group. Once the parameters are identified (as illustrated in FIG. 4), the nostalgia group is created.

Nostalgia group creator 634 is a computer program that includes program instructions for creating nostalgia groups. Nostalgia group creator 634 analyzes a plurality of different possible nostalgia group parameters. For example, the nostalgia group parameters may include one or more of cultural parameters 614 (that define certain cultural elements, such as Renaissance, Italian cuisine), existing nostalgia group parameters 606, user-entered parameters 616 (e.g., during the manual group generation), news articles 608, social activity 610 (of the user and of friends of the user), artists 618, user nostalgia answers 612, or information related to media suppliers 620 (e.g., game portal).

After the trend analysis, nostalgia group creator identifies 626 potential new nostalgia groups based on the analysis. In operation 628, the nostalgia group creator estimates the potential number of members for the group, i.e., what is the potential number of users from the user population for a newly created nostalgia group. For example, a possible new nostalgia group may have a total universe of five potential users, while another possible nostalgia group may have the potential for 50,000 users. Of course, most often the priority for the nostalgia group creator is to create nostalgia groups that appeal to a large number of users in order to leverage the nostalgia factor to as many users as possible.

If the number of potential users is greater than a predetermined threshold (operation 630), the nostalgia group creator creates the group 632 and adds the newly created group to the nostalgia groups already defined. If the number of potential users is not greater than the threshold, the nostalgia group creator returns to operation 626 (or to operation 624) to continue with the analysis for generating new nostalgia groups.

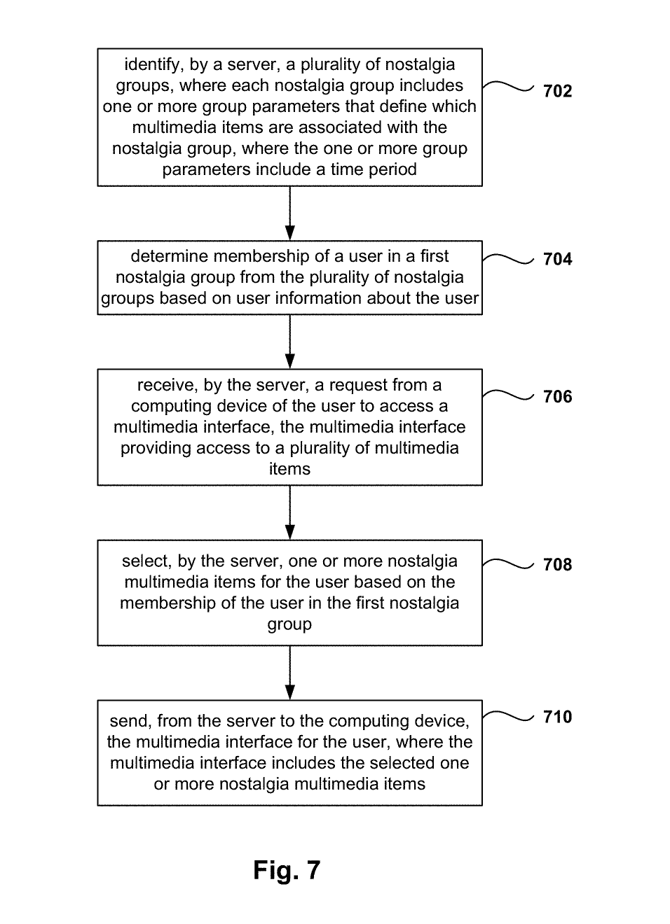

FIG. 7 is a flowchart of a method for presenting nostalgic items in a user interface, according to one embodiment. While the various operations in this flowchart are presented and described sequentially, one of ordinary skill will appreciate that some or all of the operations may be executed in a different order, be combined or omitted, or be executed in parallel.

Operation 702 is for identifying, by a server, a plurality of nostalgia groups. Each nostalgia group includes one or more group parameters that define which multimedia items are associated with the nostalgia group, where the one or more group parameters include a time period.

From operation 702, the method flows to operation 704 for determining the membership of a user in a first nostalgia group from the plurality of nostalgia groups based on user information about the user. From operation 704, the method flows to operation 706 for receiving, by the server, a request from a computing device of the user to access a multimedia interface, the multimedia interface providing access to a plurality of multimedia items (e.g., the user interface of FIG. 1, but other interfaces are also possible).

From operation 706, the method flows to operation 708 for selecting, by the server, one or more nostalgia multimedia items for the user based on the membership of the user in the first nostalgia group. In operation 710, the server sends the computing device the multimedia interface for the user, where the multimedia interface includes the selected one or more nostalgia multimedia items.

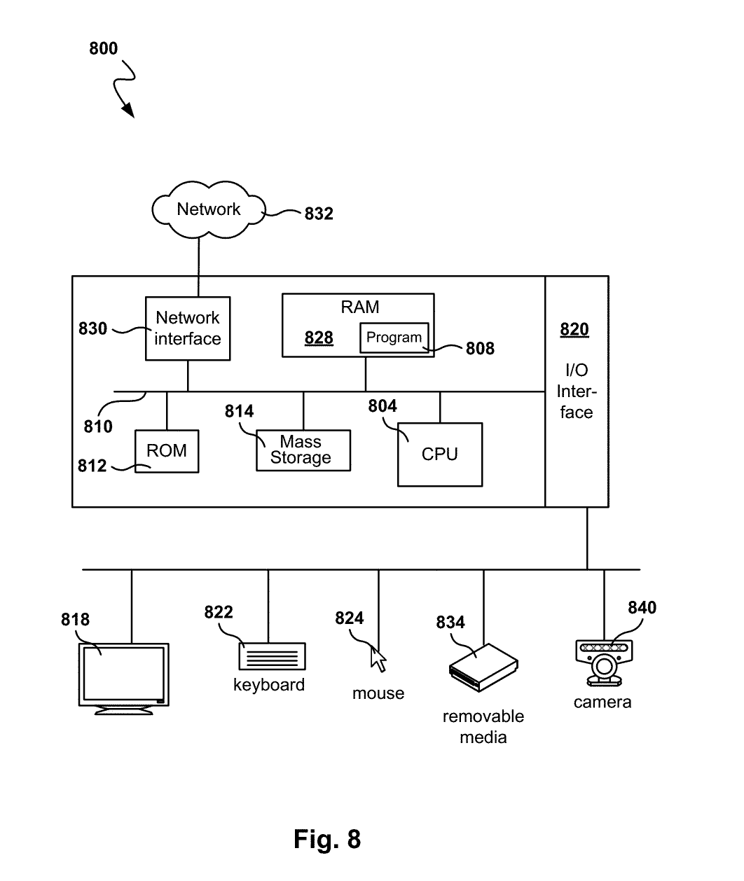

FIG. 8 is a simplified schematic diagram of a computer system for implementing embodiments. It should be appreciated that the methods described herein may be performed with a digital processing system, such as a conventional, general-purpose computer system. Special purpose computers, which are designed or programmed to perform only one function, may be used in the alternative. The computer system includes a central processing unit (CPU) 804, which is coupled through bus 810 to random access memory (RAM) 828, read-only memory (ROM) 812, and mass storage device 814. The computer program 808 resides in random access memory (RAM) 828, but can also reside in mass storage 814 or ROM 812.

Mass storage device 814 represents a persistent data storage device such as a floppy disc drive or a fixed disc drive, which may be local or remote. Network interface 830 provides connections via network 832, allowing communications with other devices. It should be appreciated that CPU 804 may be embodied in a general-purpose processor, a special purpose processor, or a specially programmed logic device. Input/Output (I/O) interface provides communication with different peripherals and is connected with CPU 804, RAM 828, ROM 812, and mass storage device 814, through bus 810. Sample peripherals include display 818, keyboard 822, cursor control 824, removable media device 834, camera 840, etc.

Display 818 is configured to display the user interfaces described herein. Keyboard 822, cursor control 824, removable media device 834, and other peripherals are coupled to I/O interface 820 in order to communicate information in command selections to CPU 804. It should be appreciated that data to and from external devices may be communicated through I/O interface 820. The embodiments can also be practiced in distributed computing environments where tasks are performed by remote processing devices that are linked through a wire-based or wireless network.

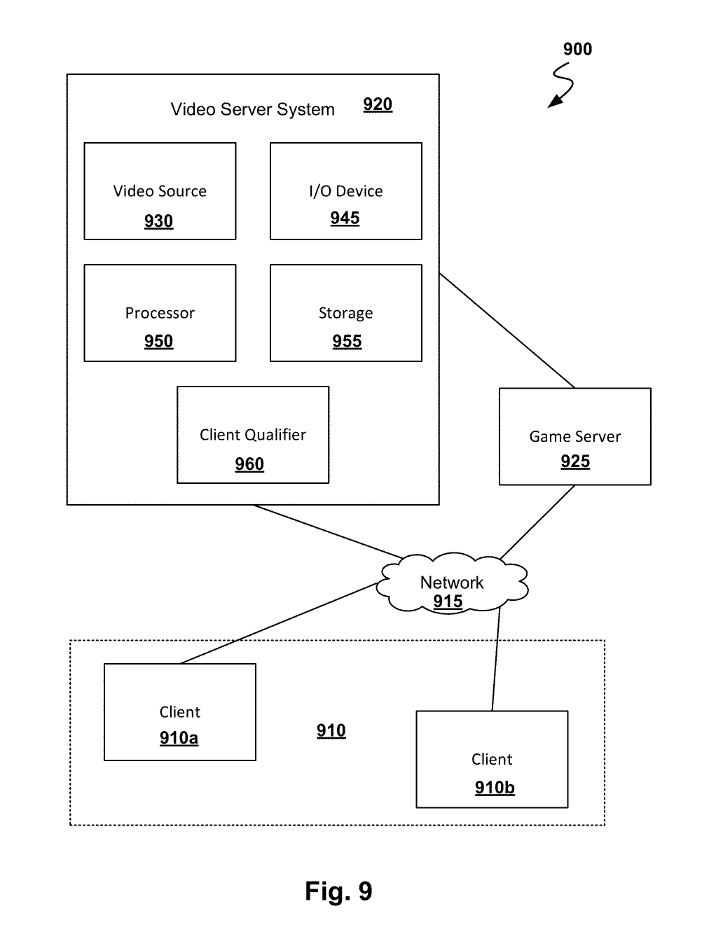

FIG. 9 is a block diagram of a game system, according to various embodiments. Game System 900 is configured to provide a video stream to one or more Clients 910 via a Network 915. Game System 900 typically includes a Video Server System 920 and an optional game server 925. Video Server System 920 is configured to provide the video stream to the one or more clients 910 with a minimal quality of service. For example, Video Server System 920 may receive a game command that changes the state of or a point of view within a video game, and provide clients 910 with an updated video stream reflecting this change in state with minimal lag time. The Video Server System 920 may be configured to provide the video stream in a wide variety of alternative video formats.

Clients 910, referred to herein individually as 910a, 910b, etc., may include head mounted displays, terminals, personal computers, game consoles, tablet computers, telephones, set top boxes, kiosks, wireless devices, digital pads, stand-alone devices, handheld game playing devices, and/or the like. Typically, clients 910 are configured to receive encoded video streams, decode the video streams, and present the resulting video to a user, e.g., a player of a game. The processes of receiving encoded video streams and/or decoding the video streams typically includes storing individual video frames in a receive buffer of the client. The video streams may be presented to the user on a display integral to client 910 or on a separate device such as a monitor or television. Clients 910 are optionally configured to support more than one game player. For example, a game console may be configured to support two, three, four or more simultaneous players. Each of these players may receive a separate video stream, or a single video stream may include regions of a frame generated specifically for each player, e.g., generated based on each player's point of view. Clients 910 are optionally geographically dispersed. The number of clients included in game system 900 may vary widely from one or two to thousands, tens of thousands, or more. As used herein, the term “game player” is used to refer to a person that plays a game and the term “game playing device” is used to refer to a device used to play a game. In some embodiments, the game playing device may refer to a plurality of computing devices that cooperate to deliver a game experience to the user. For example, a game console and a Head-Mounted Display (HMD) may cooperate with the video server system 920 to deliver a game viewed through the HMD. In one embodiment, the game console receives the video stream from the video server system 920, and the game console forwards the video stream, or updates to the video stream, to the HMD for rendering.

Clients 910 are configured to receive video streams via network 915, which may be any type of communication network including, a telephone network, the Internet, wireless networks, powerline networks, local area networks, wide area networks, private networks, and/or the like. In some embodiments, the video streams are communicated via standard protocols, such as TCP/IP or UDP/IP. Alternatively, the video streams are communicated via proprietary standards.

A typical example of clients 910 is a personal computer comprising a processor, non-volatile memory, a display, decoding logic, network communication capabilities, and input devices. The decoding logic may include hardware, firmware, and/or software stored on a computer readable medium. Systems for decoding (and encoding) video streams are well known in the art and vary depending on the particular encoding scheme used.

Clients 910 may, but are not required to, further include systems configured for modifying received video. For example, a client may be configured to perform further rendering, to overlay one video image on another video image, to crop a video image, and/or the like. For example, clients 910 may be configured to receive various types of video frames, such as I-frames, P-frames and B-frames, and to process these frames into images for display to a user. In some embodiments, a member of clients 910 is configured to perform further rendering, shading, conversion to 3D, optical distortion processing for HMD optics, or like operations on the video stream. A member of clients 910 is optionally configured to receive more than one audio or video stream. Input devices of clients 910 may include, for example, a one-hand game controller, a two-hand game controller, a gesture recognition system, a gaze recognition system, a voice recognition system, a keyboard, a joystick, a pointing device, a force feedback device, a motion and/or location sensing device, a mouse, a touch screen, a neural interface, a camera, input devices yet to be developed, and/or the like.

The video stream (and optionally the audio stream) received by clients 910 is generated and provided by Video Server System 920. This video stream includes video frames, and the audio stream includes audio frames. The video frames are configured (e.g., they include pixel information in an appropriate data structure) to contribute meaningfully to the images displayed to the user. As used herein, the term “video frames” is used to refer to frames including predominantly information that is configured to contribute to (e.g., to effect) the images shown to the user. Most of the teachings herein with regard to “video frames” can also be applied to “audio frames.”

Clients 910 are typically configured to receive inputs from a user. These inputs may include game commands configured to change the state of the video game or otherwise affect game play. The game commands can be received using input devices and/or may be automatically generated by computing instructions executing on clients 910. The received game commands are communicated from clients 910 via network 915 to Video Server System 920 and/or game server 925. For example, in some embodiments, the game commands are communicated to game server 925 via Video Server System 920. In some embodiments, separate copies of the game commands are communicated from clients 910 to game server 925 and Video Server System 920. The communication of game commands is optionally dependent on the identity of the command. Game commands are optionally communicated from client 910a through a different route or communication channel that that used to provide audio or video streams to client 910a.

Game server 925 is optionally operated by a different entity than Video Server System 920. For example, game server 925 may be operated by the publisher of a multiplayer game. In this example, Video Server System 920 is optionally viewed as a client by game server 925 and optionally configured to appear from the point of view of game server 925 to be a prior art client executing a prior art game engine. Communication between Video Server System 920 and game server 925 optionally occurs via network 915. As such, game server 925 can be a prior art multiplayer game server that sends game state information to multiple clients, one of which is game server system 920. Video Server System 920 may be configured to communicate with multiple instances of game server 925 at the same time. For example, Video Server System 920 can be configured to provide a plurality of different video games to different users. Each of these different video games may be supported by a different game server 925 and/or published by different entities. In some embodiments, several geographically distributed instances of Video Server System 920 are configured to provide game video to a plurality of different users. Each of these instances of Video Server System 920 may be in communication with the same instance of game server 925. Communication between Video Server System 920 and one or more game servers 925 optionally occurs via a dedicated communication channel. For example, Video Server System 920 may be connected to game server 925 via a high bandwidth channel that is dedicated to communication between these two systems.

Video Server System 920 comprises at least a video source 930, an I/O device 945, a processor 950, and non-transitory storage 955. Video Server System 920 may include one computing device or be distributed among a plurality of computing devices. These computing devices are optionally connected via a communications system such as a local area network.

Video source 930 is configured to provide a video stream, e.g., streaming video or a series of video frames that form a moving picture. In some embodiments, Video source 930 includes a video game engine and rendering logic. The video game engine is configured to receive game commands from a player and to maintain a copy of the state of the video game based on the received commands. This game state includes the position of objects in a game environment, as well as typically a point of view. The game state may also include properties, images, colors and/or textures of objects. The game state is typically maintained based on game rules, as well as game commands such as move, turn, attack, set focus to, interact, use, and/or the like. Part of the game engine is optionally disposed within game server 925. Game server 925 may maintain a copy of the state of the game based on game commands received from multiple players using geographically disperse clients. In these cases, the game state is provided by game server 925 to video source 930, wherein a copy of the game state is stored and rendering is performed. Game server 925 may receive game commands directly from clients 910 via network 915, and/or may receive game commands via Video Server System 920.

Video source 930 typically includes rendering logic, e.g., hardware, firmware, and/or software stored on a computer readable medium such as storage 955. This rendering logic is configured to create video frames of the video stream based on the game state. All or part of the rendering logic is optionally disposed within a graphics processing unit (GPU). Rendering logic typically includes processing stages configured for determining the three-dimensional spatial relationships between objects and/or for applying appropriate textures, etc., based on the game state and viewpoint. The rendering logic produces raw video that is then usually encoded prior to communication to clients 910. For example, the raw video may be encoded according to an Adobe Flash® standard, .wav, H.264, H.263, On2, VP6, VC-1, WMA, Huffyuv, Lagarith, MPG-x. Xvid. FFmpeg, x264, VP6-8, realvideo, mp3, or the like. The encoding process produces a video stream that is optionally packaged for delivery to a decoder on a remote device. The video stream is characterized by a frame size and a frame rate. Typical frame sizes include 800×600, 1280×720 (e.g., 720 p), 1024×768, although any other frame sizes may be used. The frame rate is the number of video frames per second. A video stream may include different types of video frames. For example, the H.264 standard includes a “P” frame and a “I” frame. I-frames include information to refresh all macro blocks/pixels on a display device, while P-frames include information to refresh a subset thereof. P-frames are typically smaller in data size than are I-frames. As used herein the term “frame size” is meant to refer to a number of pixels within a frame. The term “frame data size” is used to refer to a number of bytes required to store the frame.

In alternative embodiments video source 930 includes a video recording device such as a camera. This camera may be used to generate delayed or live video that can be included in the video stream of a computer game. The resulting video stream optionally includes both rendered images and images recorded using a still or video camera. Video source 930 may also include storage devices configured to store previously recorded video to be included in a video stream. Video source 930 may also include motion or positioning sensing devices configured to detect motion or position of an object, e.g., person, and logic configured to determine a game state or produce video-based on the detected motion and/or position.

Video source 930 is optionally configured to provide overlays configured to be placed on other video. For example, these overlays may include a command interface, log-in instructions, messages to a game player, images of other game players, video feeds of other game players (e.g., webcam video). In embodiments of client 910a including a touch screen interface or a gaze detection interface, the overlay may include a virtual keyboard, joystick, touch pad, and/or the like. In one example of an overlay a player's voice is overlaid on an audio stream. Video source 930 optionally further includes one or more audio sources.

In embodiments wherein video server system 920 is configured to maintain the game state based on input from more than one player, each player may have a different point of view comprising a position and direction of view. Video source 930 is optionally configured to provide a separate video stream for each player based on their point of view. Further, video source 930 may be configured to provide a different frame size, frame data size, and/or encoding to each of client 910. Video source 930 is optionally configured to provide 3D video.

I/O device 945 is configured for video server system 920 to send and/or receive information such as video, commands, requests for information, a game state, gaze information, device motion, device location, user motion, client identities, player identities, game commands, security information, audio, and/or the like. I/O device 945 typically includes communication hardware such as a network card or modem. I/O device 945 is configured to communicate with game server 925, network 915, and/or clients 910.

Processor 950 is configured to execute logic, e.g. software, included within the various components of video server system 920 discussed herein. For example, processor 950 may be programmed with software instructions in order to perform the functions of video source 930, game server 925, and/or a client qualifier 960. Video server system 920 optionally includes more than one instance of processor 950. Processor 950 may also be programmed with software instructions in order to execute commands received by video server system 920, or to coordinate the operation of the various elements of Game System 900 discussed herein. Processor 950 may include one or more hardware device. Processor 950 is an electronic processor.

Storage 955 includes non-transitory analog and/or digital storage devices. For example, storage 955 may include an analog storage device configured to store video frames. Storage 955 may include a computer readable digital storage, e.g. a hard drive, an optical drive, or solid state storage. Storage 915 is configured (e.g. by way of an appropriate data structure or file system) to store video frames, artificial frames, a video stream including both video frames and artificial frames, audio frame, an audio stream, and/or the like. Storage 955 is optionally distributed among a plurality of devices. In some embodiments, storage 955 is configured to store the software components of video source 930 discussed elsewhere herein. These components may be stored in a format ready to be provisioned when needed.

Video server system 920 optionally further comprises client qualifier 960. Client qualifier 960 is configured for remotely determining the capabilities of a client, such as clients 910a or 910b. These capabilities can include both the capabilities of client 910a itself as well as the capabilities of one or more communication channels between client 910a and video server system 920. For example, client qualifier 960 may be configured to test a communication channel through network 915.

Client qualifier 960 can determine (e.g., discover) the capabilities of client 910a manually or automatically. Manual determination includes communicating with a user of client 910a and asking the user to provide capabilities. For example, in some embodiments, client qualifier 960 is configured to display images, text, and/or the like within a browser of client 910a. In one embodiment, client 910a is an HMD that includes a browser. In another embodiment, client 910a is a game console having a browser, which may be displayed on the HMD. The displayed objects request that the user enter information such as operating system, processor, video decoder type, type of network connection, display resolution, etc. of client 910a. The information entered by the user is communicated back to client qualifier 960.

Automatic determination may occur, for example, by execution of an agent on client 910a and/or by sending test video to client 910a. The agent may comprise computing instructions, such as java script, embedded in a web page or installed as an add-on. The agent is optionally provided by client qualifier 960. In various embodiments, the agent can find out processing power of client 910a, decoding and display capabilities of client 910a, lag time reliability and bandwidth of communication channels between client 910a and video server system 920, a display type of client 910a, firewalls present on client 910a, hardware of client 910a, software executing on client 910a, registry entries within client 910a, and/or the like.

Client qualifier 960 includes hardware, firmware, and/or software stored on a computer readable medium. Client qualifier 960 is optionally disposed on a computing device separate from one or more other elements of video server system 920. For example, in some embodiments, client qualifier 960 is configured to determine the characteristics of communication channels between clients 910 and more than one instance of video server system 920. In these embodiments the information discovered by client qualifier can be used to determine which instance of video server system 920 is best suited for delivery of streaming video to one of clients 910.

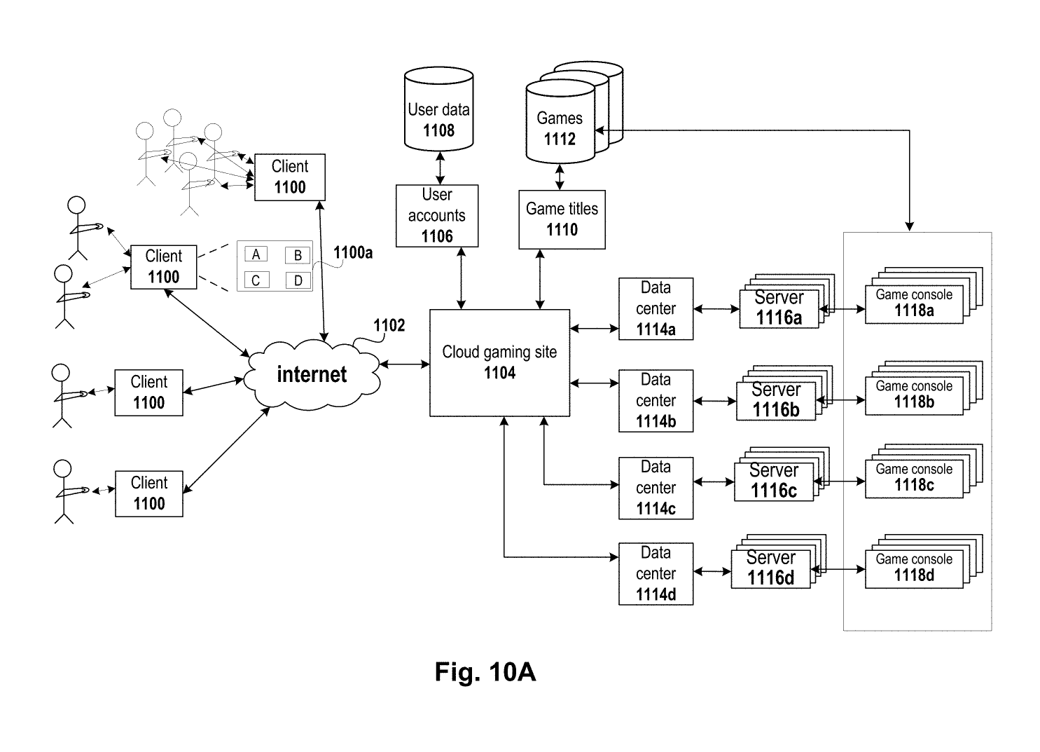

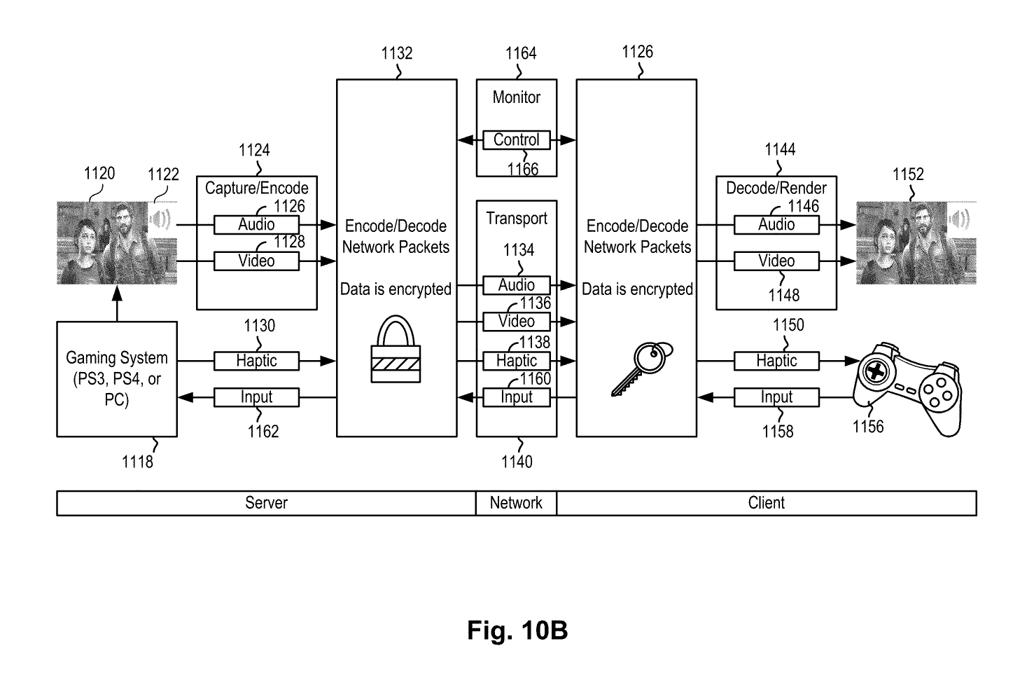

FIG. 10A illustrates a simplified block diagram of an exemplary system that is used to preload game content onto a cloud game server, in accordance with an embodiment. FIG. 10A illustrates an exemplary system used to load game files for a game available through a cloud gaming site. The system includes a plurality of client devices 1100 that are communicatively connected to the cloud gaming site 1104 over a network 1102, such as the Internet. When a request to access the cloud gaming site 1104 is received from a client device 1100, the cloud gaming site 1104 accesses user account information 1106 stored in a user data store 1108 to identify a user associated with a client device through which the request is initiated. In some embodiments, the cloud gaming site may also validate the identified user in order to determine all the games the user is authorized to view/play. Following user account identification/validation, the cloud gaming site accesses a game titles data store 1110 to identify the game titles that are available at the game cloud site for the user account initiating the request. The game titles data store 1110, in turn, interacts with a games database 1112 to obtain the game titles for all the games that are available for the cloud gaming site. As new games are introduced, the games database 1112 will be updated with the game code and the game titles data store 1110 will be provided with game titles information for the newly introduced games. The client device from where the request is initiated may or may not be registered with the cloud gaming site, when the request was initiated. If the user of the client device initiating the request is not a registered user, then the cloud gaming site may identify the user as a new user and select the game titles (for e.g., a default set of game titles) that are appropriate for a new user. The identified game titles are returned to the client device for presenting on a display screen 1100a.

User interaction at one of the game titles rendered on the client device is detected and a signal is sent to the cloud gaming site. The signal includes the game title information where the user interaction was detected and the user interaction registered at the game title. In response to the signal received from the client device, the cloud gaming site proactively determines a data center where the game is being hosted and sends a signal to the identified data center to load the game associated with the game title for which the user interaction is detected. In some embodiments, more than one data center may be hosting the game. In such embodiments, the cloud gaming site may determine the geographic location of the client device initiating the request and identify a data center that is geographically close to the client device and signal the data center to pre-load the game. The geo location of the user may be determined using a Global Position System (GPS) mechanism within the client device, the client's IP address, the client's ping information, to name a few. Of course, the aforementioned ways to detect the geo location of the user may be exemplary and other types of mechanisms or tools may be used to determine the geo location of the user. Identification of a data center that is close to the client device can minimize latency during user interaction with the game. In some embodiments, the identified data center may not have the required bandwidth/capacity to host the game or may be overused. In these embodiments, the cloud gaming site may identify a second data center that is geographically close to the client device. The loading of the game includes loading game code and executing an instance of the game.

In response to receiving the signal from the cloud gaming site, the identified data center may select a server at the data center to instantiate the game on the server. The server is selected based on the hardware/software capabilities available and the game requirements. The server may include a plurality of game consoles and the server may determine which one of the plurality of game consoles to use to load the game. The game console may be similar to an independent game console, or may be a rack-mounted server or a blade server. The blade server, in turn, may include a plurality of server blades with each blade having required circuitry for instantiating a single dedicated application, such as the game. Of course, the game console described above is exemplary and should not be considered restrictive. Other types of game consoles, including game stations, etc., and other forms of blade server may also be engaged for hosting the identified game.

Once the game console is identified, the generic game-related code for the game is loaded onto the game console and a signal is returned to the client device via the cloud gaming site over the network identifying the game console on which the game is instantiated. The loaded game is thus made available to the user.

FIG. 10B is a flow diagram conceptually illustrating various operations which are performed for streaming a cloud video game to a client device, in accordance with implementations of the disclosure. The gaming system 1118 executes a video game and generates raw (uncompressed) video 1120 and audio 1122. The video 1120 and audio 1122 are captured and encoded for streaming purposes, as indicated at reference 1124 in the illustrated diagram. The encoding can provide for compression of the video and audio streams to reduce bandwidth usage and optimize the gaming experience. Examples of encoding formats include H.265/MPEG-H, H.264/MPEG-4, H.263/MPEG-4, H.262/MPEG-2, WMV, VP6/7/8/9, etc.

The encoded audio 1126 and encoded video 1128 are further packetized into network packets, as indicated at reference numeral 1132, for purposes of transmission over a network such as the Internet. The network packet encoding process can also employ a data encryption process, thereby providing enhanced data security. In the illustrated implementation, audio packets 1134 and video packets 1136 are generated for transport over the network, as indicated at reference 1140.

The gaming system 1118 additionally generates haptic feedback data 1130, which is also packetized into network packets for network transmission. In the illustrated implementation, haptic feedback packets 1138 are generated for transport over the network, as further indicated at reference 1140.

The foregoing operations of generating the raw video and audio and the haptic feedback data, encoding the video and audio, and packetizing the encoded audio/video and haptic feedback data for transport are performed on one or more servers which collectively define a cloud gaming service/system. As indicated at reference 1140, the audio, video, and haptic feedback packets are transported over a network, such as and/or including the Internet. The audio packets 1134, video packets 1136, and haptic feedback packets 1138, are decoded/reassembled by the client device to define encoded audio 1146, encoded video 1148, and haptic feedback data 1150 at the client device. If the data has been encrypted, then the network packets are also decrypted. The encoded audio 1146 and encoded video 1148 are then decoded by the client device, as indicated at reference 1144, to generate client-side raw audio and video data for rendering on a display device 1152. The haptic feedback data 1150 can be processed/communicated to produce a haptic feedback effect at a controller device 1156 or other interface device through which haptic effects can be rendered. One example of a haptic effect is a vibration or rumble of the controller device 1156.

It will be appreciated that a video game is responsive to user inputs, and thus, a similar procedural flow to that described above for transmission and processing of user input, but in the reverse direction from client device to server, can be performed. As shown, a user operating controller device 1156 may generate input data 1158. This input data 1158 is packetized at the client device for transport over the network to the cloud gaming system. The input data packets 1160 are unpacked and reassembled by the cloud gaming server to define input data 1162 on the server-side. The input data 1162 is fed to the gaming system 1118, which processes the input data 1162 to update the game state of the video game.

During transport (ref. 1140) of the audio packets 1134, video packets 1136, and haptic feedback packets 1138, the transmission of data over the network can be monitored to ensure the cloud game stream quality of service. For example, network conditions can be monitored as indicated by reference 1164, including both upstream and downstream network bandwidth, and the game streaming can be adjusted in response to changes in available bandwidth. That is, the encoding and decoding of network packets can be controlled based on present network conditions, as indicated by reference 1166.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive and not to be limited to the details given herein, but may be modified within the scope and equivalents of the appended claims.

What is claimed is:

1. A method for creating a user interface for a computing device, the method comprising:
identifying, by a server, a plurality of nostalgia groups, wherein each nostalgia group includes one or more group parameters that define which multimedia items are associated with the nostalgia group, wherein the one or more group parameters include a time period;
determining membership of a user in a first nostalgia group from the plurality of nostalgia groups based on user information about the user;
receiving, by the server, a request from a computing device of the user to access a multimedia interface, the multimedia interface providing access to a plurality of multimedia items;
selecting, by the server, one or more nostalgia multimedia items for the user based on the membership of the user in the first nostalgia group; and
sending, from the server to the computing device, the multimedia interface for the user, wherein the multimedia interface includes the selected one or more nostalgia multimedia items, wherein operations of the method are executed by a processor.

2. The method as recited in claim 1, wherein the user information about the user includes answers of the user to nostalgia-related questions, wherein the membership of the user in the first nostalgia group is inferred from the answers of the user to the nostalgia-related questions, wherein each nostalgia-related question is associated with a respective nostalgia time period.

3. The method as recited in claim 1, further including:
presenting in the multimedia interface a question to the user, wherein an answer to the question provides information for determining if the user is interested in one or more of the nostalgia groups.

4. The method as recited in claim 3, further including:
analyzing the user information about the user to identify a candidate nostalgia group for the user; and
selecting a question based on the identified candidate nostalgia group.

5. The method as recited in claim 4, further including:
adding the user to the candidate nostalgia group based on an answer received from the user.

6. The method as recited in claim 1, further including:
invoking an API to access social information from a social server associated with a social network, the social information including a profile of the user in the social network and list of friends of the user in the social network.

7. The method as recited in claim 1, wherein the group parameters further include one or more of a music type, or an artist name, or a movie type, or a game type.

8. The method as recited in claim 1, wherein determining membership includes:
for each nostalgia group from the plurality of groups, analyzing one or more of history of user multimedia selections, or user profile, or nostalgia group affiliations of friends of the user in a social network, or existing nostalgia groups where the user is a member.

9. The method as recited in claim 1, wherein the multimedia items include one or more songs, or one or more games, or one or more movies.

10. The method as recited in claim 1, wherein the one or more group parameters further include a geographic location of interest to the user.

11. The method as recited in claim 1, wherein the multimedia interface includes:
one or more games;
one or more songs;
one or more movies; and
one or more suggestions for the selected one or more nostalgia multimedia items.

12. The method as recited in claim 1, further including:
receiving a selection of a first nostalgia multimedia item; and
streaming to the computing device the first nostalgia multimedia item.

13. A server for providing a multimedia interface, the server comprising:
a memory for storing a computer program and information about a plurality of nostalgia groups, wherein each nostalgia group includes one or more group parameters that define which multimedia items are associated with the nostalgia group, wherein the one or more group parameters include a time period;
a network connection configured to receive a request from a computing device of a user to access a multimedia interface, the multimedia interface providing access to a plurality of multimedia items; and
a processor configured to execute the computer program, wherein the processor determines membership of the user in a first nostalgia group from the plurality of nostalgia groups based on user information about the user;
wherein the processor selects one or more nostalgia multimedia items for the user based on the membership of the user in the first nostalgia group;
wherein the processor sends to the computing device, via the network connection, the multimedia interface for the user, the multimedia interface including the selected one or more nostalgia multimedia items.

14. The server as recited in claim 13, wherein the multimedia interface includes :
one or more games accessible from a game server;
one or more songs accessible from a music server;
one or more movies accessible from a streaming media server; and one or more suggestions for the selected one or more nostalgia multimedia items accessible from the game server, or the music server, or the streaming media server.

15. The server as recited in claim 13, the multimedia interface further includes a question to the user, wherein an answer to the question provides information for determining if the user is interested in one or more of the nostalgia groups.

16. The server as recited in claim 13, wherein the processor invokes an API to access social information from a social server associated with a social network, the social information including a profile of the user in the social network and list of friends of the user in the social network.

17. The server as recited in claim 13, wherein the group parameters further include one or more of a music type, or an artist name, or a movie type, or a game type.

18. The server as recited in claim 13, wherein the time period includes a decade.

19. A non-transitory computer-readable storage medium storing a computer program for creating a user interface for a computing device, the computer-readable storage medium comprising:
program instructions for identifying, by a server, a plurality of nostalgia groups, wherein each nostalgia group includes one or more group parameters that define which multimedia items are associated with the nostalgia group, wherein the one or more group parameters include a time period;
program instructions for determining membership of a user in a first nostalgia group from the plurality of nostalgia groups based on user information about the user;
program instructions for receiving, by the server, a request from a computing device of the user to access a multimedia interface, the multimedia interface providing access to a plurality of multimedia items;
program instructions for selecting, by the server, one or more nostalgia multimedia items for the user based on the membership of the user in the first nostalgia group; and
program instructions for sending, from the server to the computing device, the multimedia interface for the user, wherein the multimedia interface includes the selected one or more nostalgia multimedia items.

20. The storage medium as recited in claim 19, further including:
program instructions for presenting in the multimedia interface a question to the user, wherein an answer to the question provides information for determining if the user is interested in one or more of the nostalgia groups;
program instructions for analyzing the user information about the user to identify a candidate nostalgia group for the user;
program instructions for selecting a question based on the identified candidate nostalgia group; and
program instructions for adding the user to the candidate nostalgia group based on an answer received from the user.
